(19) United States
(12) Patent Application Publication
(10) Pub. No.: US 2026/0151280 A1
(43) Pub. Date: Jun. 4, 2026

(54) UPDATED SEAT

(71) Applicant: Ease Seating Systems, Inc., Clio, MI (US)

(72) Inventors: Jeremy Yaklin, Columbiaville, MI (US); Nickxit Bhardwaj, Columbiaville, MI (US)

(21) Appl. No.: 19/346,468

(22) Filed: Sep. 30, 2025

Related U.S. Application Data
(60) Provisional application No. 63/701,553, filed on Sep. 30, 2024.

(51) Int. Cl. A61G 5/10; A47C 7/14

(52) U.S. Cl. CPC A61G 5/1045; A47C 7/142

(57) ABSTRACT

A seat cushion assembly is provided that includes a cushion body having a top surface, a bottom surface, a central passage, and a lower cavity. A bladder is positionable on the top surface of the cushion body, the bladder including at least one bladder portion with a communication port. A control assembly is disposed within the lower cavity of the cushion body and includes a pump and at least one valve coupled to the pump, the valve having a communication port. A hose extends between the communication port of the valve and the communication port of the bladder to enable fluid communication therebetween. A cover extends over and encapsulates at least a portion of the cushion body, the bladder, and the control assembly.

### CROSS-REFERENCE TO RELATED APPLICATION

This application claims priority from U.S. Patent Appl. Ser. No. 63/701,553 filed Sep. 30, 2024, entitled “Updated Seat”, the entire specification of which is hereby incorporated by reference in its entirety.

### BACKGROUND OF THE DISCLOSURE

### 1. Field of the Disclosure

The disclosure relates in general to seating surfaces, and more particularly, to a plurality of different inflatable seating assemblies that are utilized in association with, for example, wheelchairs and the like to provide those which have physical mobility challenges changes in pressure points and pressure areas. The seating surfaces can be utilized on wheelchairs, as well as other seating surfaces which may be stationary or which may be mobile, such as wheelchair racers, trikes, and the like. The disclosure is not limited to any particular use of the inflatable seat cushion.

### 2. Background Art

For those that are confined to wheelchairs and the like, it is known that extended seating often results in the same portion of the body experiencing pressure. This can lead to discomfort, bed sores and infection. By varying the position of the pressure points, such problems can be minimized if not outright avoided.

Many solutions have been developed to assist with the movement of pressure points between a seating surface and the body. While such solutions have been provided,

Drawbacks remain. Many of these solutions are cumbersome, and difficult to operate, install, remove and otherwise manipulate. Other deficiencies remain. The present disclosure is directed to a seat cushion assembly designed to enhance comfort, adjustability, and integration of support mechanisms. The assembly generally comprises a cushion body, a bladder, a control assembly, and a cover, with various configurations and features as described below.

In one embodiment, the cushion body has a top surface, a bottom surface opposite the top, a central passage, and a lower cavity. A bladder is positionable on the top surface of the cushion body and includes at least one bladder portion with at least one communication port for fluid transfer. The control assembly includes a pump and at least one valve coupled to the pump, with a communication port for the valve. The control assembly is positionable within the lower cavity of the cushion body, and a hose extends between the valve port and the bladder port to provide fluid communication. A cover extends over and encapsulates at least a portion of the cushion body, the bladder, and the control assembly.

In certain embodiments, the hose is routed through the central passage of the cushion body and may be oriented in a generally linear configuration between the bladder and the control assembly. The communication ports of the bladder and the valve may be oriented to face each other to simplify connection. The control assembly may further include an inlet hose member extending from the pump, which may itself be oriented in a generally linear fashion and, in some versions, oriented opposite to the direction of the hose extending to the bladder. The cushion body may define a front, and the control assembly may also define a front, with the two fronts substantially corresponding to facilitate installation and alignment. In this arrangement, the inlet hose member may extend from the front of the control assembly.

The bladder may include an upper and lower panel joined by a plurality of seals to form two or more distinct bladder portions, each portion having a dedicated communication port. In such embodiments, the control assembly may include a separate valve for each bladder portion, allowing independent inflation and adjustment. The bladder may also include side wing portions, each attachable to opposite sides of the cushion body to provide lateral support.

The control assembly may be housed within a protective housing that accommodates the pump, valve(s), and optionally other components. In alternative embodiments, the cushion body defines a cavity in which the control assembly is at least partially positionable. A hose extends between the bladder port and the valve, and a cover may extend over the cushion body, bladder, and control assembly.

The control assembly may further include a remote connecting module associated with the cover and electrically coupled to the control assembly, enabling external control. A power supply may also be incorporated into the control assembly to support the pump and valves. In certain embodiments, the pump, valves, and power supply are positioned within the housing. The housing may have a bottom surface that corresponds to the bottom of the cushion body when received in the cavity, while the top of the housing may be spaced below the top surface of the cushion body to preserve comfort and ergonomics.

Collectively, these embodiments provide a seat cushion assembly in which a bladder system can be inflated or deflated through an integrated control assembly, with fluid lines routed through passages of the cushion body for a clean arrangement, multiple bladder portions with independent valve control for customizable support, and protective covering to integrate and conceal the functional components.

### SUMMARY OF THE DISCLOSURE

The present disclosure is directed to a seat cushion assembly designed to enhance comfort, adjustability, and integration of support mechanisms. The assembly generally comprises a cushion body, a bladder, a control assembly, and a cover, with various configurations and features as described below.

In one embodiment, the cushion body has a top surface, a bottom surface opposite the top, a central passage, and a lower cavity. A bladder is positionable on the top surface of the cushion body and includes at least one bladder portion with at least one communication port for fluid transfer. The control assembly includes a pump and at least one valve coupled to the pump, with a communication port for the valve. The control assembly is positionable within the lower cavity of the cushion body, and a hose extends between the valve port and the bladder port to provide fluid communication. A cover extends over and encapsulates at least a portion of the cushion body, the bladder, and the control assembly.

In certain embodiments, the hose is routed through the central passage of the cushion body and may be oriented in a generally linear configuration between the bladder and the control assembly. The communication ports of the bladder and the valve may be oriented to face each other to simplify connection. The control assembly may further include an inlet hose member extending from the pump, which may itself be oriented in a generally linear fashion and, in some versions, oriented opposite to the direction of the hose extending to the bladder. The cushion body may define a front, and the control assembly may also define a front, with the two fronts substantially corresponding to facilitate installation and alignment. In this arrangement, the inlet hose member may extend from the front of the control assembly.

The bladder may include an upper and lower panel joined by a plurality of seals to form two or more distinct bladder portions, each portion having a dedicated communication port. In such embodiments, the control assembly may include a separate valve for each bladder portion, allowing independent inflation and adjustment. The bladder may also include side wing portions, each attachable to opposite sides of the cushion body to provide lateral support.

The control assembly may be housed within a protective housing that accommodates the pump, valve(s), and optionally other components. In alternative embodiments, the cushion body defines a cavity in which the control assembly is at least partially positionable. A hose extends between the bladder port and the valve, and a cover may extend over the cushion body, bladder, and control assembly.

The control assembly may further include a remote connecting module associated with the cover and electrically coupled to the control assembly, enabling external control. A power supply may also be incorporated into the control assembly to support the pump and valves. In certain embodiments, the pump, valves, and power supply are positioned within the housing. The housing may have a bottom surface that corresponds to the bottom of the cushion body when received in the cavity, while the top of the housing may be spaced below the top surface of the cushion body to preserve comfort and ergonomics.

Collectively, these embodiments provide a seat cushion assembly in which a bladder system can be inflated or deflated through an integrated control assembly, with fluid lines routed through passages of the cushion body for a clean arrangement, multiple bladder portions with independent valve control for customizable support, and protective covering to integrate and conceal the functional components.

### BRIEF DESCRIPTION OF THE DRAWINGS

The disclosure will now be described with reference to the drawings wherein:

FIG. 1 of the drawings is a partial perspective view of the seat cushion assembly of the present disclosure, showing in particular, communication with an outside device in a wireless manner;

FIG. 2 of the drawings is a perspective view of the seat cushion assembly of the present disclosure;

FIG. 3 of the drawings is a partial side elevational view of the seat cushion assembly of the present disclosure, showing, in particular, the remote communication module;

FIG. 4 of the drawings is a perspective view of the cushion body with the bladder being positioned thereon prior to attachment of the first and second side wing portions;

FIG. 5 of the drawings is a top plan view of the bladder;

FIG. 6 of the drawings is a bottom plan view of the bladder;

FIG. 7 of the drawings is a perspective view of the cushion body;

FIG. 8 of the drawings is a cross-sectional view of the cushion body;

FIG. 9 of the drawings is a bottom plan view of the cushion body and the control assembly;

FIG. 10 of the drawings is a perspective view of the control assembly;

FIG. 11 of the drawings is a perspective view of the control assembly with the top of the housing removed;

FIG. 12 of the drawings is a cross-sectional view of the seat cushion assembly;

FIG. 13 of the drawings is a cross-sectional view of the seat cushion assembly;

FIG. 14 of the drawings is a perspective view of another configuration of the cushion body with the bladder being positioned thereon prior to attachment of the first and second side wing;

FIG. 15 of the drawings is a cross-sectional view of the configuration of FIG. 14;

FIG. 16 of the drawings is a top plan view of another configuration of the bladder;

FIG. 17 of the drawings is a bottom plan view of the bladder of FIG. 15;

FIG. 18 of the drawings is a top plan view of another configuration of the cushion body;

FIG. 19 of the drawings is a bottom plan view of the cushion body of FIG. 17;

FIG. 20 of the drawings is a cross-sectional view of the cushion body of FIG. 17; and

FIG. 21 of the drawings is a cross-sectional view of another configuration of the control assembly.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

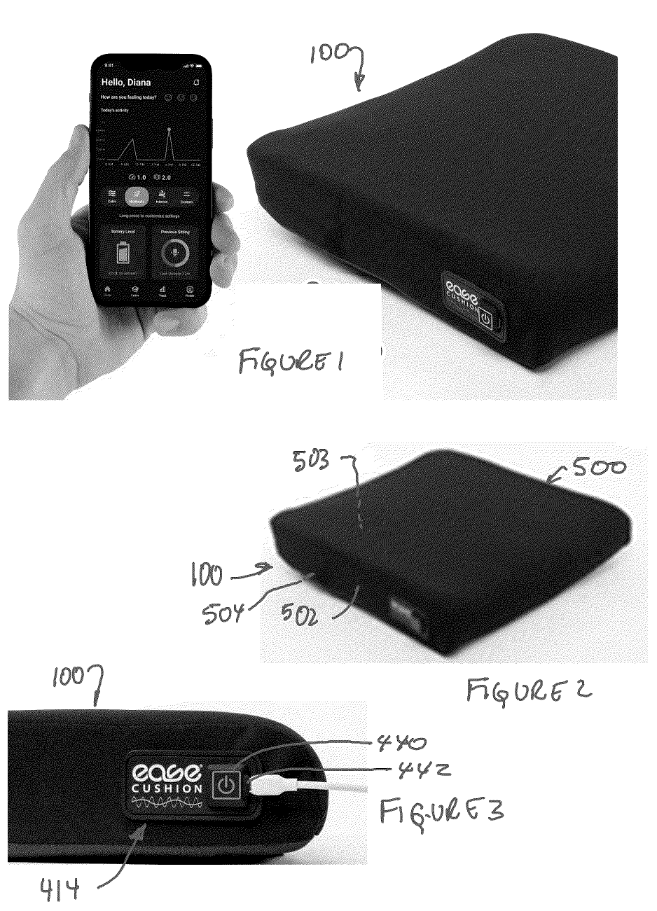

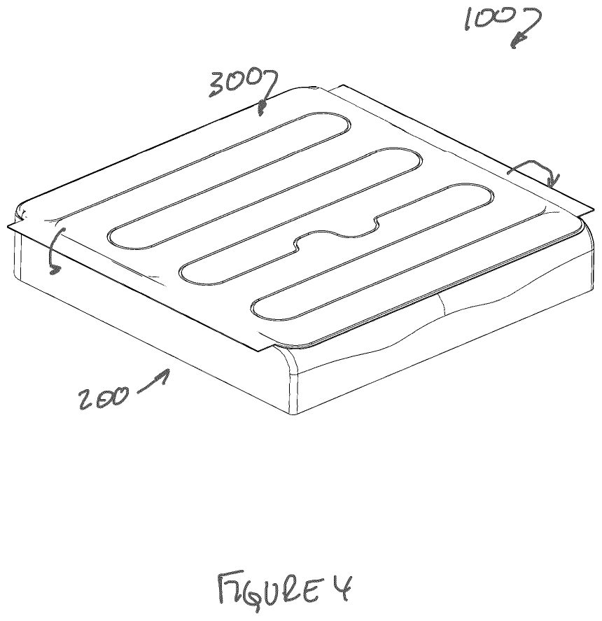

Referring now to the drawings and in particular to FIGS. 1 and 2, seat cushion assembly is shown generally at 100. The seat cushion assembly is useful in any number of environments, including, but not limited to an environment that is for quadriplegic and paraplegic users wherein the pressures on the legs can be varied through the use of pneumatic inflatable chambers. One such use can be in association with wheelchairs, as well as other environments, such as chairs, sofas, car seating, sporting events, among others. Indeed, there is no particular limitation on the environments where such a cushion may be utilized.

The seat cushion assembly is shown in FIGS. 1, 2, 4 and 10 as comprising cushion body 200, bladder 300, control assembly 400 and cover 500. The cushion body 200 is shown as comprising a generally unitary foam member, that may comprise a molded foam member (such as a urethane foam), or a cut foam member. In other configurations, the foam member may comprise a polymer fiber member or a cushion formed from multiple layers of different materials, many of which may comprise a polymer based foam, whereas others may comprise woven or non-woven materials that may be natural or synthetic.

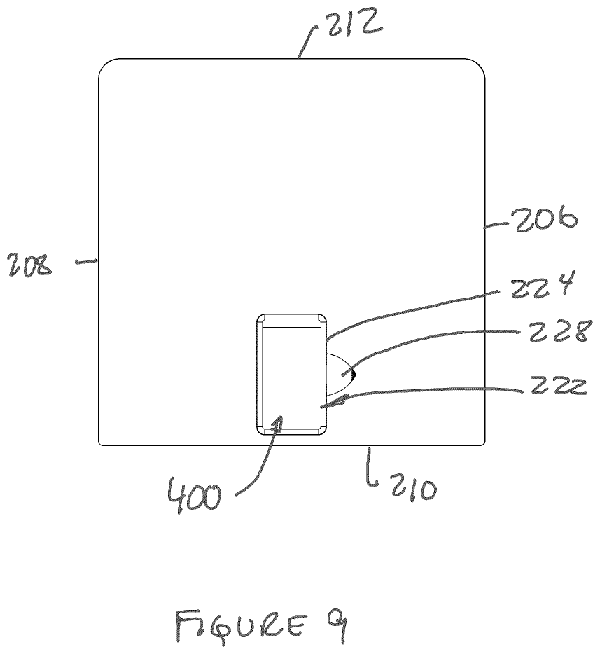

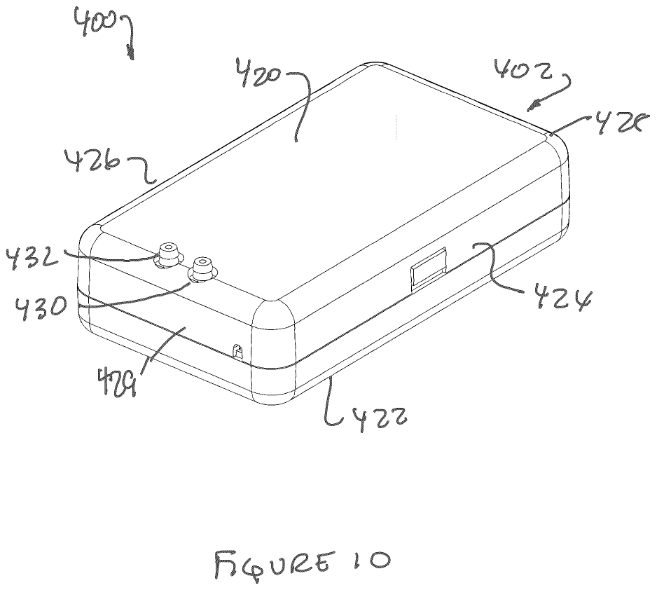

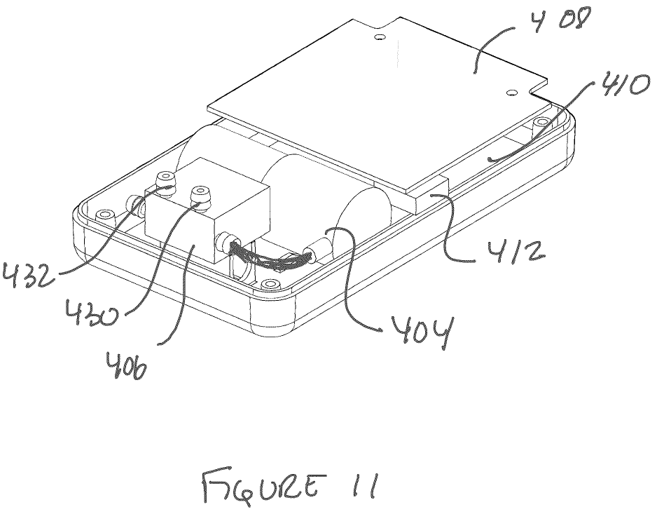

In the configuration shown, and with reference to FIGS. 7, 8 and 9, the cushion body comprises a singular integrally molded foam member which is generally a rectangular cubic configuration (with surface variations) defining a top 202, bottom 204, first side 206, second side 208, front 210 and back 212. In the configuration shown, the top may include a surface topography that may include a buttock region 230 proximate back 212 which comprises a generally outwardly concave surface variation encircled by a rim for a portion thereof. A first leg region 232 and a second leg region 234 extend from the buttock region 230 in a spaced apart manner to the front 210 (generally parallel to the first side 206 and the second side 208). In the configuration shown, the first leg region and the second leg region define a generally outwardly concave channel with the central hump 236 positioned therebetween (which, in turn, comprises a generally convex structure). A first side lip 240 is formed between the outer side of the first leg region 232 and the first side 206, and a second side lip 242 is formed between the outer side of the second leg region 234 and the second side 208. As will be understood, the buttock region is configured to receive the buttocks of the user, with the lower portion of the thighs extending along the first leg region 232 and the second leg region 234.

A central passage 220 is defined in the cushion body 200 between the first leg region 232 and the second leg region 234, spaced apart from the front 210, leading to lower cavity 222 also defined in the cushion body 200. In the configuration shown, the central passage 220 is positioned closer to the front 210 than the back 212, and is symmetrical about an axis that bisects the cushion body between the front 210 and the back 212. In the configuration shown, the passage comprises a generally rectangular opening that is wider (i.e., the width being defined by the distance as it relates to the first side and the second side) than long (i.e., the length being defined by the distance as it relates to the the front and the back). In addition, the configuration of the central passage may be varied between the top and the bottom so that it may be of a non-uniform cross-sectional configuration. For example, the wall corresponding to the back wall in the configuration shown is arcuate and narrows from the top eventually meeting the lower cavity 222.

The lower cavity 222 is configured to receive the control assembly 400 therewithin, with the central passage 220 providing access to the same from the top. The lower cavity 222 includes sidewalls 224, top wall 226 and access slot 228. The top wall 226 includes the opening to the central passage 220 such that there is access to the communication ports 430, 432 from the top, with the sidewalls 224 generally being shape mating to the control assembly 200, and in particular to the housing thereof. In the configuration shown, the lower opening of the lower cavity 222 matches the configuration of the housing 402 so as to allow for ease of access. The access slot 228 is extends from one of the sidewalls 224 so as to provide access to a side port (such as, a port to which a remote communication module 414 can be coupled). It will be understood that the configuration of the lower cavity and the central passage may be varied, such as, for example, in the positioning, with the understanding that the present configuration positions the control assembly (within the lower cavity), in an orientation wherein the user will likely not feel the housing (which tends to be more rigid than the cushion body, in some configurations). It will be understood that depending on the configuration, the central passage and the lower cavity may be embedded within the cushion body or may be positioned or extend from the top 202 of the cushion body. It will be understood that, preferably, the control assembly is maintained within the footprint of the cushion body, and preferably within the volume defined by the cushion body.

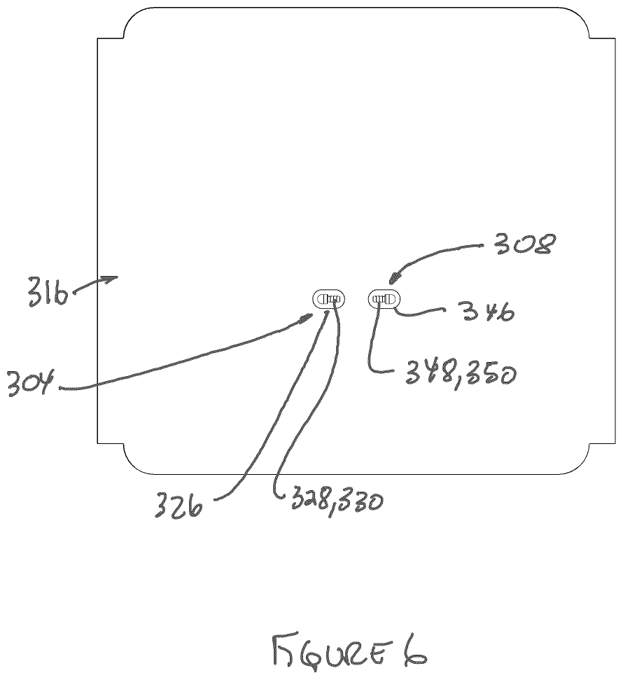

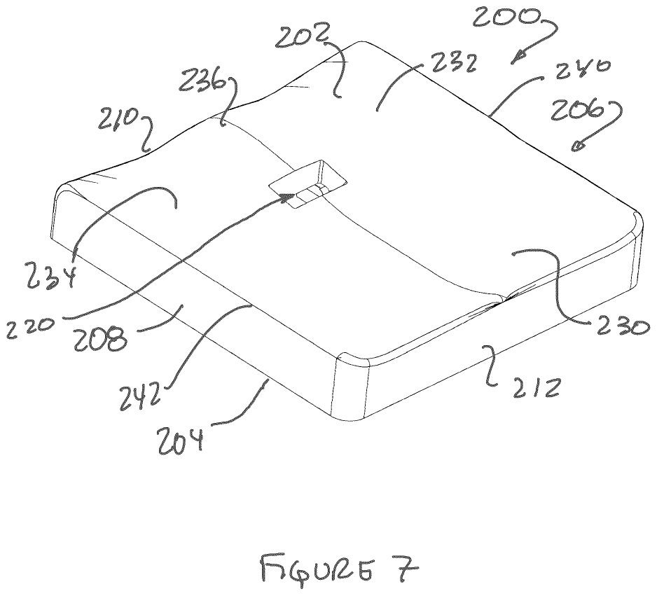

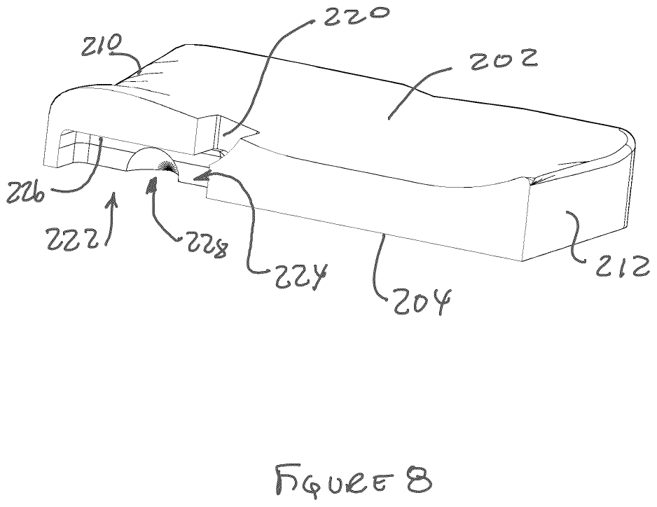

With reference to FIGS. 4, 5 and 6, bladder 300 is shown as comprising upper panel 314, lower panel 316 and seals 318. In the configuration shown, the bladder includes a plurality of portions that are formed by forming seals to join the upper panel and the lower panel together. In other configurations, the bladder may be formed from a number of different panels or from multiple different separate structures. In the configuration shown, the bladder may be formed from an polymer such as a natural or synthetic rubber, among other materials.

Bladder 300 is configured to include first bladder portion 302, first communication port 304, second bladder portion 306, second communication port 308, first side wing portion 310 and second side wing portion 312. The first bladder portion 302 includes first manifold 320 with first cross members 322 extending therefrom, one of which includes first port attachment region 324. The second bladder portion 306 includes second manifold 340 with second cross members 342 extending therefrom, one of which includes second port attachment region 344. In the configuration shown, the first cross members 322 extend generally perpendicularly from the first manifold 320 as spaced apart fingers to a distal end. Similarly, the second cross members 342 extend generally perpendicularly from the second manifold 340 as spaced apart fingers to a distal end, with the first cross members 322 and the second cross members 342 being positioned so as to nest within each other in an alternating fashion, such that the distal end of the cross members reach the opposing, with the outermost fingers extending to the end of the opposing manifold.

The first port attachment region 324 and the second port attachment region 344 are adjacent to each other and positioned along adjacent nesting fingers of the first and second bladder portions, respectively. It will be understood that the first and second port attachment regions generally correspond to the central passage 220 when the bladder is installed on the cushion body.

In the configuration shown, the first side wing portion 310 includes first inner surface 360, first outer surface 362, first inner edge 364 and first outer edge 366. The first inner edge extends along the outer side of the first manifold 320 and the final one of the second cross members. Similarly, the second side wing portion 312 includes second inner surface 370, second outer surface 372, second inner edge 374 and second outer edge 376. The second inner edge extends along the outer side of the second manifold 340 and the final one of the first cross members. As will be explained below with the assembly, the wing portions are configured to overlap the opposing first and second sides 206, 208 and to be adhered thereto.

The first communication port 304 is includes first base flange 326 and first coupling port 328. The first base flange is attached to the lower panel 326 of the bladder 300 proximate the first port attachment region 324, with the first port 328 providing communication with the first cavity defined by the first bladder portion. In the configuration shown, the first coupling port has a portion that extends perpendicular to the first base flange and a second portion that is perpendicular thereto, and that terminates with first barbs 330.

Similarly, second communication port 308 includes second base flange 346 and second coupling port 348. The second base flange is attached to the lower panel 326 of the bladder 300 proximate the second port attachment region 344, with the second port 348 providing communication with the second cavity defined by the second bladder portion. In the configuration shown, the second coupling port has a portion that extends perpendicular to the second base flange and a second portion that is perpendicular thereto, and that terminates with second barbs 350. Further, in the configuration shown, the second portions face each other and are disposed along an axis that is generally parallel to the front of the cushion body when assembled. Other configurations are contemplated.

It will be understood that while two independent bladders are shown, in other configurations, there may be a single bladder or greater than two bladders, and while the bladders are shown to be generally symmetrical or mirror images of each other, variations are contemplated such that different bladders can be activated for different regions. It is also contemplated that in some configurations, portions of the bladders may be overlapping.

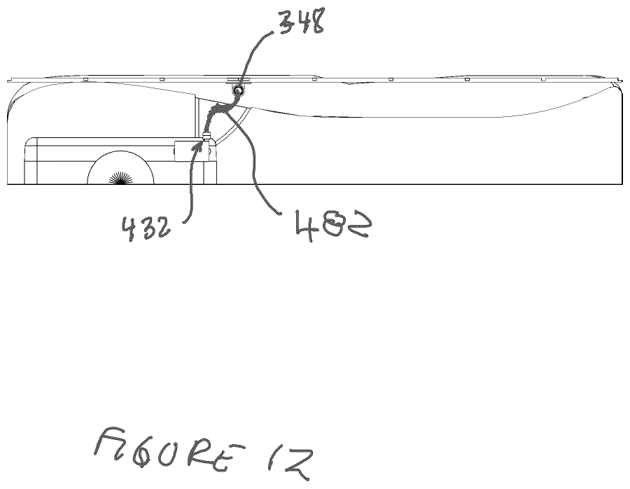

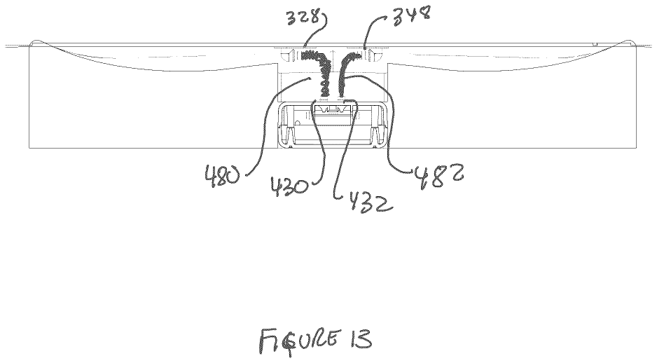

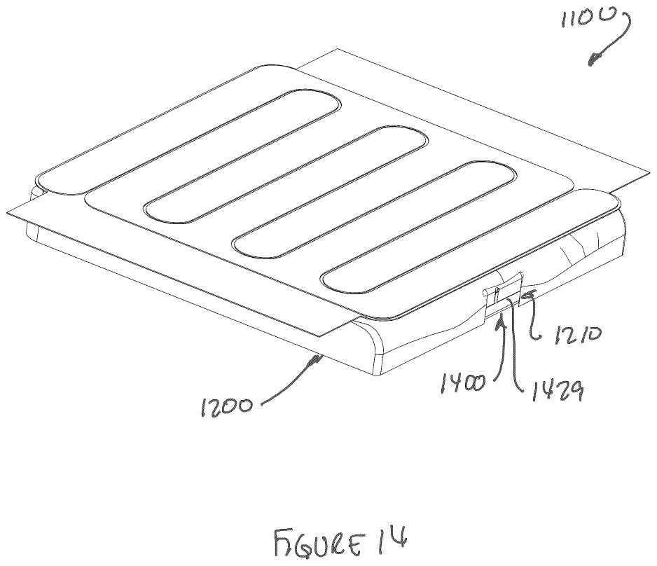

With reference to FIG. 10 through 13, control assembly 400 is shown as comprising housing 402, pump 424, 406, control board 408, power supply 410, connector 412 and remote communication module 414. Housing 402 includes top 420, bottom 422, first side 424, second side 426 and front 428 and back 429. The housing is sized so as to fit within the lower cavity. In the configuration shown, the battery is contained within the housing 402. In the configuration shown, the valve 406 includes first communication port 430 and second communication port 432 which extend in a spaced apart side by side orientation on the top 420 of the housing 402. Internally, the configuration can be similar to that of U.S. Pat. No. 12,042,053 issued to Yalkin, the entire specification of which is hereby incorporated by reference in its entirety.

As will be explained in the assembly, the first communication port 430 of the valve 406 is attached to the first coupling port 328 of the first bladder portion by way of a first hose member 380. Due to the relative position of the first communication port and the first coupling port, the first hose member, as being offset relative to each other in at least two planes, the first hose member leaves the first communication port and extends both rearward and outward to connect to the first coupling port 328. In the configuration shown, the two ports are perpendicular to each other, but offset outwardly and also offset in a front-back orientation. Such a configuration it has been found improves the connectivity between the components and the reliability of the same.

Similarly, the second communication port 432 of the valve 406 is coupled to the second coupling port 348 of the second bladder portion through second hose member 382. As with the first hose member, the second hose member is offset in both an outward direction and a rearward direction from the second communication port to the second coupling port. It will be understood that other relationships are contemplated, wherein the ports may be organized in different orientations relative to each other, and relative to the first hose. In the configuration shown, the two hoses are generally mirror images of each other, whereas in other configurations, they may be different between the two hoses. Preferably, each hose is offset in both a side to side direction and a front to back direction, or, in other configurations, in at least two axis or planes.

The remote communication module 414 is positioned on the first side 206 of the cushion body and is coupled electrically to the connector 412 which is on the first side 424 of the housing 402 (and which is accessible through the access slot 228. The remote communication module includes an on/off switch 440 as well as a charging/data port 442, which may comprise a USB type C connector, while other connectors are contemplated for use. It will be understood that the control board may include wireless communication, including but not limited to RF, WIFI, Bluetooth, among others. In such configurations, the control assembly 400 can be placed in communication with a remote device, such as, for example, a computer, a tablet, a smartphone and/or a smart watch, among others. In other configurations, the communication may be wired to such devices using the charging/data port. It will be understood that the remove communication module may be stitched to cover 500 (Described below), and as such, may be machine washable. In such cases, the remote communication module may be water resistant and/or waterproof so as to allow such washing. In other configurations, the remote communication module may be removable.

The cover 500 is shown as comprising a plurality of stitched panels 502 that define a cavity 503 with an access opening 504. The access opening 504 may be closed using a zipper, hook and loop fasteners, snaps, tabs or the like. In the configuration shown, the cushion body 200 can be inserted into the cavity 503 through the access opening 504. The access opening can be closed so as to preclude removal and/or viewing of the cushion body.

To assemble the seat cushion assembly 100 of the present disclosure, the user is provided with the components. The bladder 300 is positioned over the cushion body such that the first side wing portion and the second side wing portion are extended over the first side 206 and the second side 208, respectively. They may be adhered through an adhesive, double sided tape, or welding (heat, RF, ultrasound, among others). Such an overlap and attachment limits undesirable movement of the bladder relative to the cushion body and tends to improve the control of the bladder during inflation and deflation.

Once attached, due to the position, the first communication port and the second communication port are accessible through the central passage 220 and accessible to the lower cavity 222. The first hose member and the second hose member are attached to the first coupling port and the second coupling port. At the other end, they are attached to the first communication port and the second communication port of the control assembly 400. Once connected, the control assembly can be placed into the lower cavity 222.

Once positioned, the cover may be provided, at which time, the remote communication module 414 of the control assembly that is attached (i.e., stitched or adhered) to the cover can be connected to the connector 412 of the control assembly. The cushion body along with the bladder and the control assembly are then inserted into the cavity of the cover through the access opening. Once positioned, the access opening can be closed.

The user can then place the seat cushion assembly onto an outside surface, such as a wheelchair, a chair, a sofa, among others, and can turn the device on with the remote communication module (or a control device such as described above). When in need of a charge, the user can attach an outside power source to the charging port 442 of the remote communication module.

When desired, the cover can be removed, washed and replaced. In other configurations, it may be replaced with a new cover.

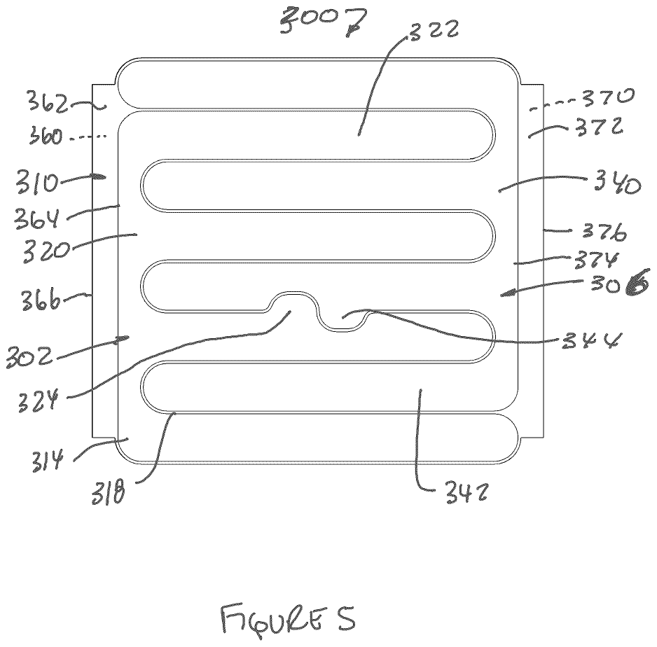

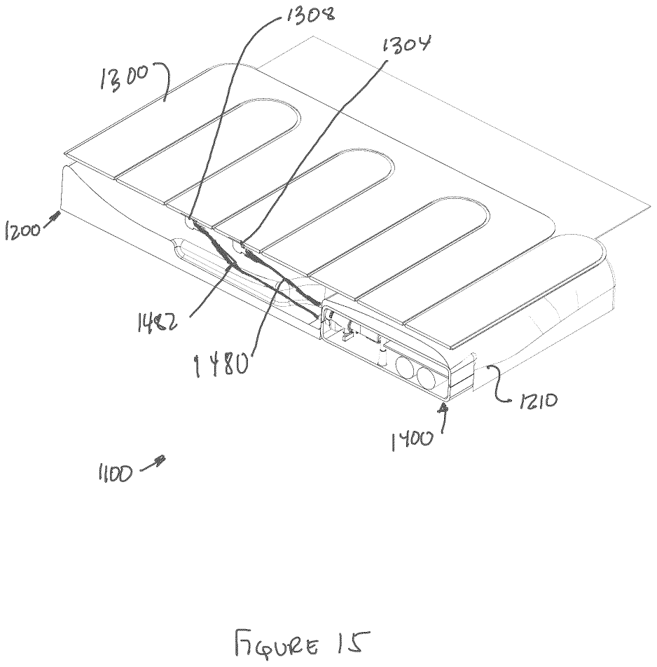

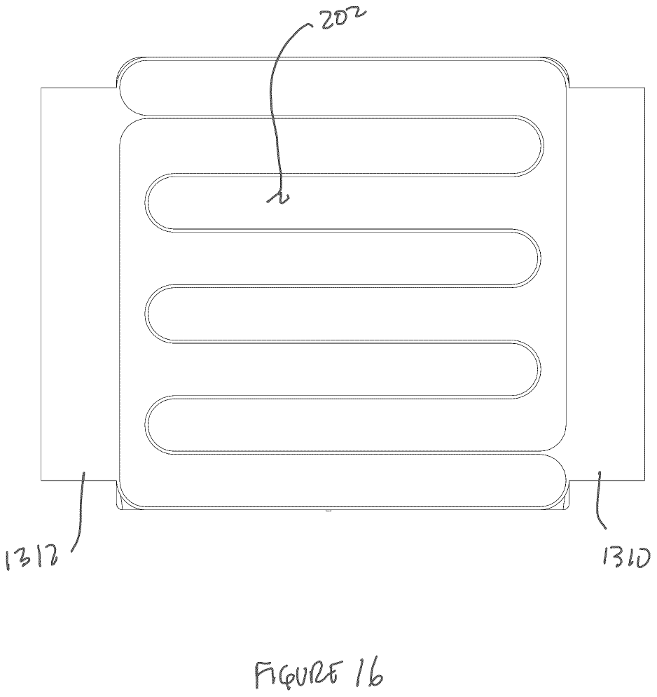

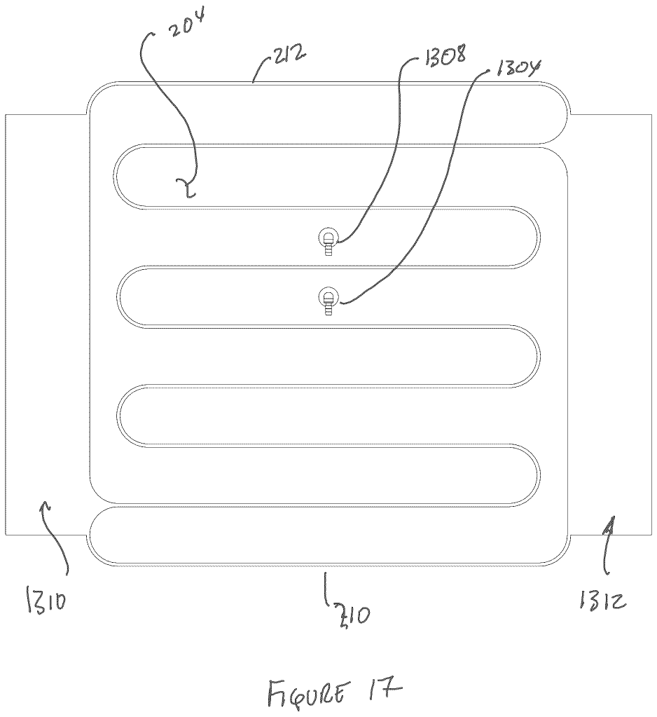

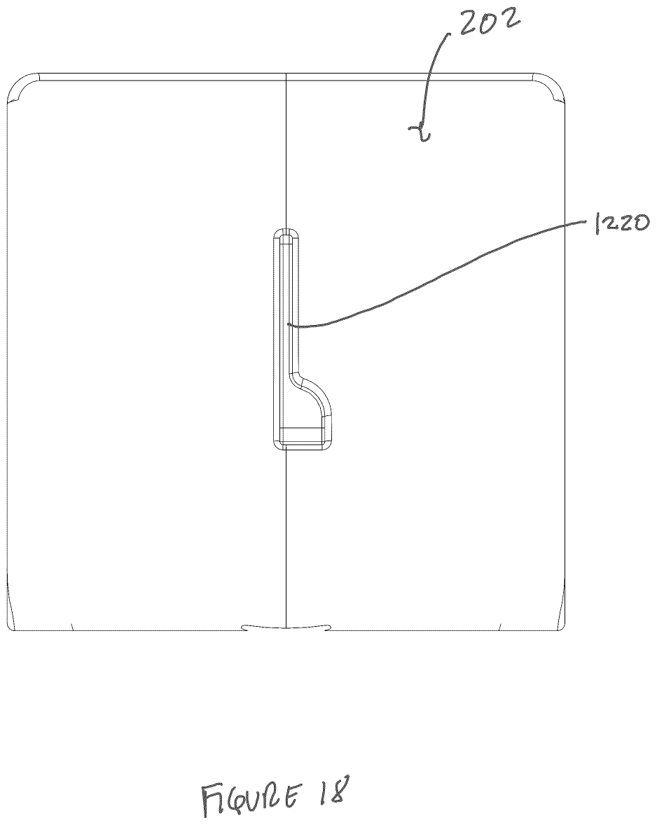

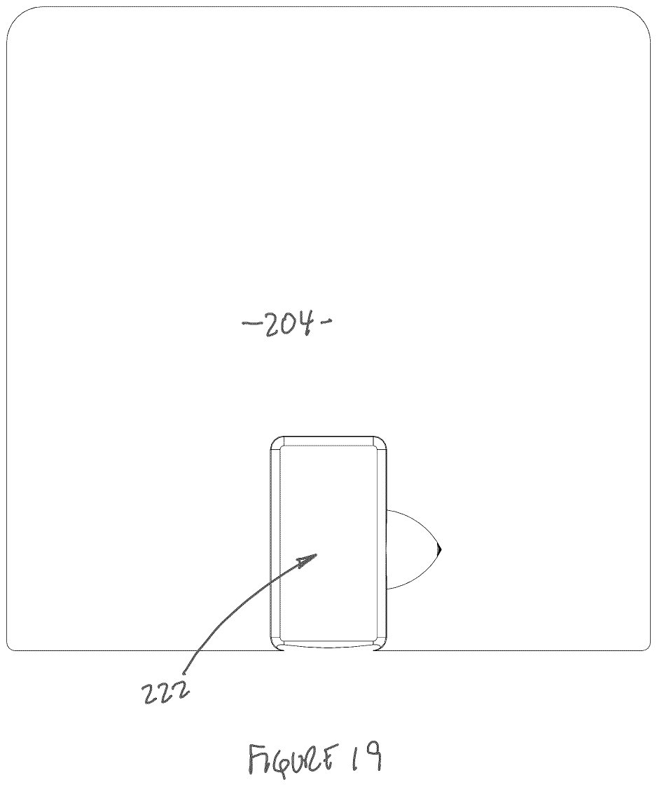

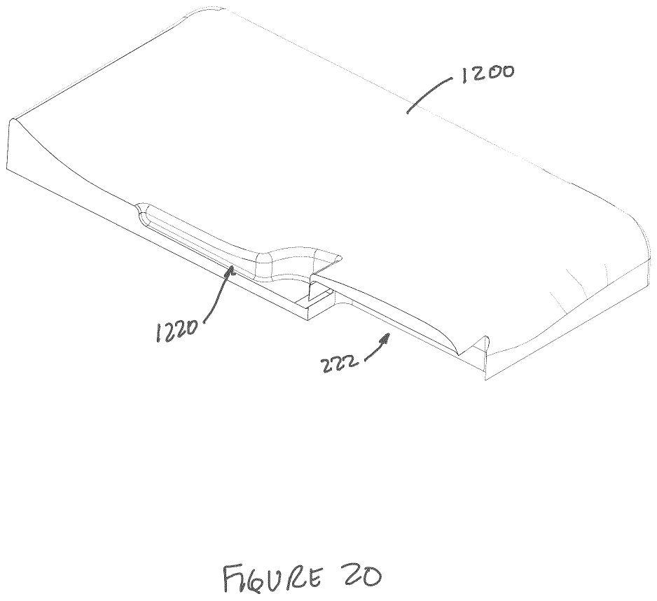

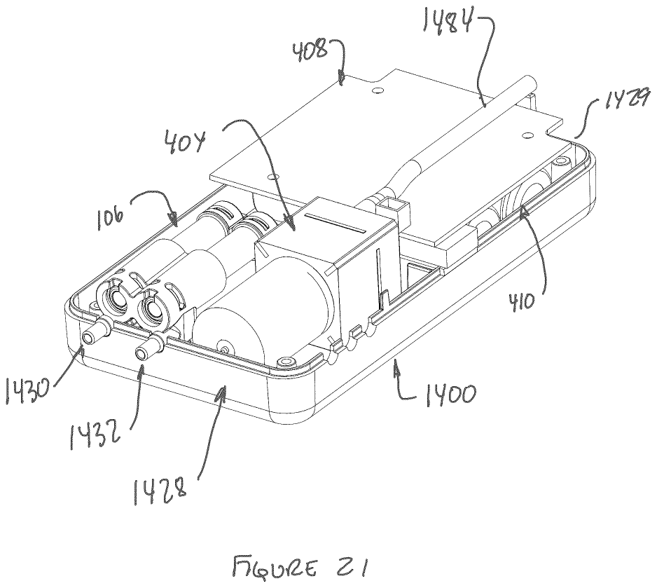

Another configuration of the seat cushion assembly is shown in FIGS. 14 through 21 generally at 1100. The seat cushion is similar to that shown in FIGS. 1 through 13, with at least some of the differences being set forth hereinbelow, with other differences being shown through a comparison of the Figures of the configurations.

In the configuration shown, among other differences, the configuration is shown as having the control assembly 1400 terminating at the front 1210 of the cushion body 1200. In such a configuration, the control assembly includes an inlet port defined by an inlet hose member which extends through the control assembly within the housing, and extends to the front 1429 of the control assembly 1400, and preferably comprises a generally linearly oriented inlet hose member 1484.

Similarly, the first hose member 1480 and the second hose member 1482 are generally oriented in a linear fashion as well between the control assembly 1400 and the respective one of the first communication port 1304 and the second communication port 1308. In the configuration shown, the first communication port 1304 and the second communication port 1308 are oriented in a substantially linear orientation, and both openings face the front of the cushion body when installed. In some configurations, the two ports may be offset relative to each other.

Similarly, the first communication port and the second communication port 1430, 1432 are oriented in a side by side configuration at the back 1428 of the housing of the control assembly. As such, the first hose member 1480 and the second hose member 1482 can be directed generally linearly (although it will be understood that there may be a rounded configuration, or an arcuate configuration between the components). Additionally, with the ports of the bladder being spaced apart from the ports of the control assembly, movement caused by the application of force onto the bladder and cushion (i.e., through a user sitting on the cushion or moving around on a cushion to transfer weight to different regions thereof, or through inflation and deflation of the bladder, or a combination thereof), the hoses are able to translate vertically and horizontally while minimizing inadvertent damage thereto.

At the same time, the cushion body 1200 includes a central passage 1220 defining a slot like cavity that is generally linear and narrowing, as the first hose member and the second hose member are generally linear and as the hoses approach the communication ports of the bladder, they may be vertically stacked, or partially vertically stacked, while being horizontally spaced apart at the control assembly. Of course, other configurations are contemplated, however, by keeping the first and second hose members elongated and generally linear (i.e., without curvatures extending beyond 90°, and more preferably 80°, and more preferably 60°, and more preferably 40°, and more preferably 20°, and more preferably 10°). Additionally, it is preferred that the length of the hoses are preferably in excess of 2.5″ long and more preferably at least 4″ long, and more preferably at least 6″ long, or longer. Generally such lengths allow for relative movement while minimizing the interaction between the ports, and, inadvertent disengagement of the hoses.

In the configuration shown, the control assembly may be, the magnetic latching solenoid valve assembly, while other configurations are contemplated. Additionally, by keeping the different hoses substantially linear, interruption or resistance to the flow of air through the hoses can be minimized. In the configuration shown, the first and second side wing portions 1310, 1312, respectively, can be widened so as to have a greater surface area with which to bond the same to the base (i.e., increased surface area). Additionally, it will be understood that where the bladder is a lower profile cushion body (i.e., a 2″ thick cushion body as opposed to a 3″ thick cushion body), a portion of the widened first and second side wing portions can be folded over the bottom of the cushion and attached thereto. It will be understood that the configuration of the cushion is such that additional thickness configurations are contemplated, wherein minimal changes to the central passage and lower cavity.

It will be understood that features from either of the configurations shown may be mixed and matched together to form various seat cushion assemblies within the principles set forth in the present disclosure.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A seat cushion assembly comprising:
a cushion body having a top and a bottom opposite the top, the cushion having a central passage and a lower cavity;
a bladder positionable on the top surface of the cushion body, the bladder having at least one bladder portion with at least one communication port into the at least one bladder portion;
a control assembly including a pump and at least one valve coupled to the pump, the at least one valve having a communication port, the control assembly being positionable within the lower cavity of the cushion, the control assembly further including a hose extending between the communication port of the at least one valve to the at least one communication port of the bladder;
a cover extending encapsulating at least a portion of each one of the cushion body, the bladder and the control assembly.

2. The seat cushion assembly of claim 1 wherein the hose is positioned within the central passage.

3. The seat cushion assembly of claim 1 wherein the hose is oriented in a generally linear configuration between the at least one communication port of the bladder and the communication port of the control assembly.

4. The seat cushion assembly of claim 1 wherein the at least one communication port and the communication port of the control assembly are face each other.

5. The seat cushion assembly of claim 1 wherein the control assembly includes an inlet hose member extending from the pump.

6. The seat cushion assembly of claim 5 wherein the inlet hose member is oriented in a generally linear fashion.

7. The seat cushion assembly of claim 6 wherein the inlet hose member is oriented in a direction opposite that of the hose extending between the valve and the bladder.

8. The seat cushion assembly of claim 1 wherein the cushion body defines a front and the control assembly defines a front, wherein the front of the cushion body and the front of the control assembly substantially correspond.

9. The seat cushion assembly of claim 8 wherein the control assembly includes inlet hose member extending from the pump to the front of the control assembly.

10. The seat cushion assembly of claim 1 wherein the bladder further includes a upper panel and a lower panel that are joined together with a plurality of seals to define at least two separate bladder portions, the at least one communication port comprises at least one communication port associated with each of the at least two separate bladder portions.

11. The seat cushion assembly wherein the control assembly further includes at least one valve for each of the at least two separate bladder portions.

12. The seat cushion assembly of claim 1 wherein the bladder further includes a first side wing portion and a second side wing portion opposite the first side wing portion, with the first and second side wing portions being attachable to opposing sides of the cushion body.

13. The seat cushion assembly of claim 1 wherein the control assembly further comprises a housing, with the pump and the at least one valve being positioned therein.

14. A seat cushion assembly comprising:
a cushion body having a top and a bottom opposite the top, the cushion having a cavity;
a bladder positionable on the top surface of the cushion body, the bladder having at least one bladder portion with at least one communication port into the at least one bladder portion;
a control assembly including a pump and at least one valve coupled to the pump, with a hose extending between the at least one communication port and the and the at least one valve, the control assembly being at least partially positionable within the cavity defined in the cushion.

15. The seat cushion assembly of claim 14 further comprising a cover extending over the cushion body, the bladder and the control assembly.

16. The seat cushion assembly of claim 14 further comprising a remote connecting module associated with the cover, with an electrical coupling to the control assembly.

17. The seat cushion assembly of claim 14 wherein the control assembly further includes a power supply.

18. The seat cushion assembly of claim 14 wherein the control assembly includes a housing, with the pump, the at least one valve and the power supply are positioned within the housing.

19. The seat cushion assembly of claim 18 wherein the housing includes a bottom, and wherein when positioned within the cavity of the cushion body, the bottom of the housing corresponds to the bottom of the cushion body.

20. The seat cushion assembly of claim 18 wherein the control assembly has a top which is spaced apart from the top of the cushion body.
